(19) United States
(12) Patent Application Publication
(10) Pub. No.: US 2002/0171859 A1
(43) Pub. Date: Nov. 21, 2002

(54) Method and device for printing confidential document on a network

(76) Inventors: Wilson Chen, Hsinchu (TW); Ben Lin, Hsinchu (TW)

Correspondence Address: TROJAN LAW OFFICES, 9250 WILSHIRE BLVD, SUITE 325, BEVERLY HILLS, CA, 90212

(21) Appl. No.: 09/860,396

(22) Filed: May 16, 2001

(51) Int. Cl. G06F 3/12; G06F 13/00; G06F 7/04; G08B 29/00; H04L 9/32; H04L 9/14

(52) U.S. Cl. 358/1.14; 358/1.15; 340/5.2

(57) ABSTRACT

A method for printing a confidential document in a network system having a printer connected to a printer server is provided. The method includes steps of setting a first password for a print job of said confidential document; sending data of the print job to the printer server and holding down the print job; inputting a second password into the printer server; and printing the document by the printer when the first password and the second password are identical.

### FIELD OF THE INVENTION

The present invention relates to network printing, specifically to a method and device for printing documents securely on a network.

### BACKGROUND OF THE INVENTION

Networking is advantaged in that hardware and software can be shared. FIG. 1 illustrates a conventional print server workflow. Computers 11 and 12 share the printer 14 through the printer server 13. The operation of such a system is dependent on a network operating system (NOS). The print jobs are managed and controlled by the printer server 13. The printer server 13 will send print jobs to printer 14 as soon as print jobs get to print queue. Such a workflow is insecure because confidential documents will be printed out at unpredictable time. Unfortunately, the printers are usually placed at a certain distance away from the user, or even in another room. It is difficult to prevent the confidential document from being exposed to other people during the printing process.

It is then observed that the conventional printer server cannot handle the confidential documents, unless the printer server is for a private use. However, a privately used printer server will loss the ability of printing sharing. It is then attempted by the present invention to deal with the above-mentioned problems.

### SUMMARY OF THE INVENTION

An object of the present invention is to provide a method and device for printing a confidential document on a network.

According to the present invention, a method for printing a confidential document in a network system having a printer connected to a printer server is provided. The method includes steps of setting a first password for a print job of said confidential document; sending data of the print job to the printer server and holding down the print job; inputting a second password into the printer server; and printing the document by the printer when the first password and the second password are identical.

According to a preferred embodiment of the present invention, the second password is inputted into the printer server by a input device connected to the printer server. The input device may be a personal identification number pad.

The printer server can be a specific device or a personal computer. The method may further includes steps of presetting a first user name and inputting a second user name to the printer server, and the document is printed when the first user name and the first password are identical to the second user name and the second password.

Preferably, the first user name and the first password are preset within the printer server.

The printer server preferably includes a storage device for storing the first user name and the first password.

The printer server may inquire the first password from either the storage device or another printer server.

The print job is preferably sent from a client of the network system to the printer server, and the method further includes a step of selecting a confidential printing option on the client before the data of the print job is sent to the printer server.

In another preferred embodiment, the first password is inputted into the client when the confidential printing option is selected.

The present invention also provides a secure printing device adapted to be used with a network having a plurality of computers and a printer. The device includes a data receiving device for receiving a printing data from one of the plurality of computers; a password input device for inputting therefrom a password; and a print job control device electrically connected between the data receiving device and the password input device for holding the printing data down and allowing the printing data to be printed by the printer only when a legal password is inputted from the password input device.

In one preferred embodiment, the device further includes a storage device electrically connected to the print job controlling device for storing therein a pre-stored password, wherein the password inputted by the password input device is identified as the legal password when the password is identical to the pre-stored password.

Preferably, a preset password is inputted from the data receiving device, and the password inputted by the password input device is identified as the legal password when the password is identical to the preset password.

Preferably, a user name is inputted from the password input device together with the password.

In another preferred embodiment, the device further includes a storage device for storing therein a pre-stored user name and a prestored password, wherein the password inputted by the password input device is identified as the legal password when the user name and the password are identical to the pre-stored user name and the preset password respectively.

The device preferably further includes a data outputting device electrically connected between the print job control device and the printer for outputting the printing data to the printer.

The present invention may best be understood through the following description with reference to the accompanying drawings, in which:

### BRIEF DESCRIPTION OF THE DRAWINGS

FIG. 1 illustrates a network having a conventional print server;

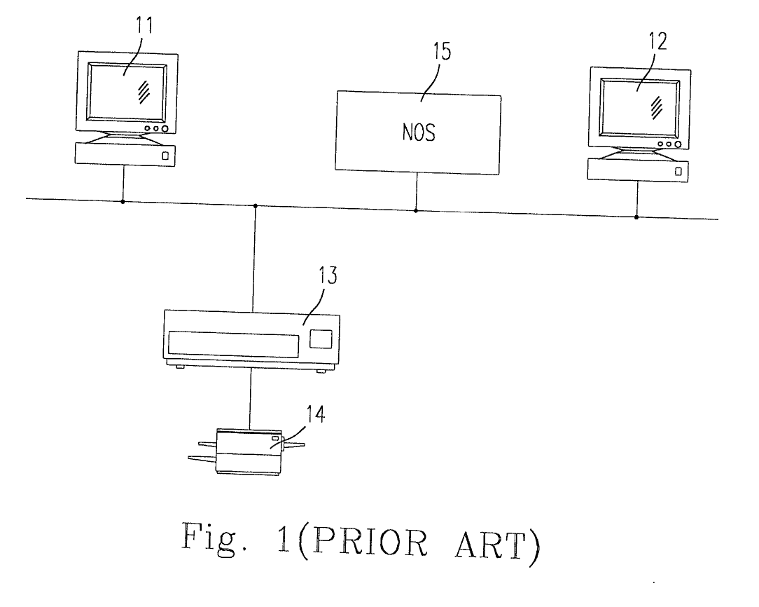

FIG. 2 shows a secure printing architecture according to a preferred embodiment of the present invention;

FIG. 3 illustrates another secure printing architecture according to a preferred embodiment of the present invention; and

FIG. 4 is a block diagram illustrating a preferred embodiment of a printer server according to the present invention.

### DETAILED DESCRIPTION OF THE PREFERRED EMBODIMENTS

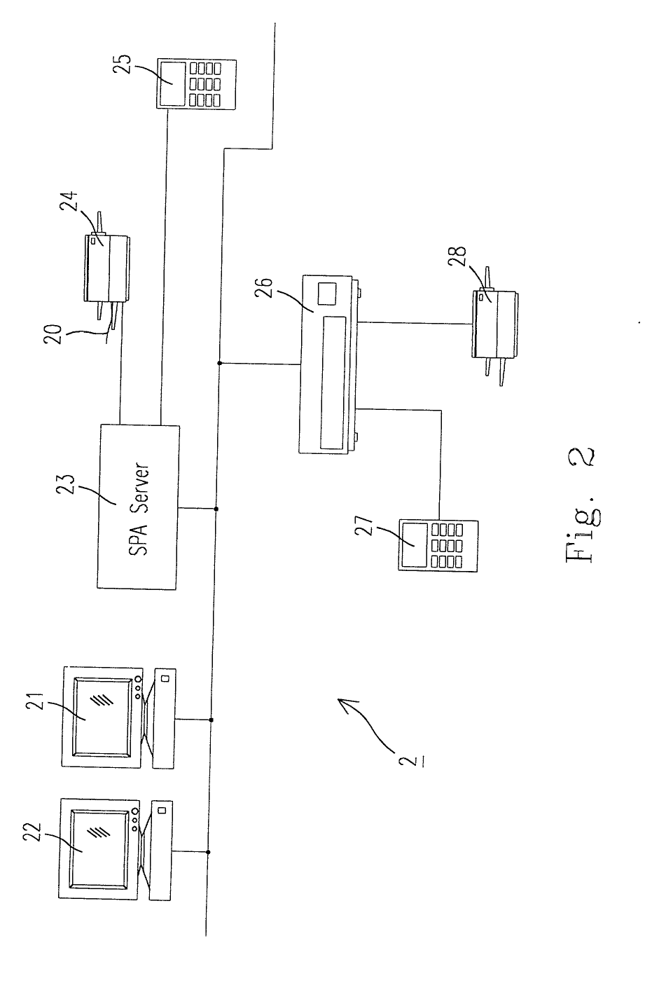

FIG. 2 illustrates a network system 2 having computers 21 and 22, a secure printing architecture (SPA) server 23, a printer server 26, printers 24 and 28 and personal identification number (PIN) pads 25 and 27. The printers 24 and 28 and personal identification number pads 25 and 27 are connected to the SPA server 23 and the printer server 26 respectively.

The SPA server 23 includes functions of file sharing and print job spooling. A preset user name and a preset password may be either stored within the SPA server 23 or sent from the client computers 21 or 22 to the SPA server 23. When a confidential document is to be printed by a user through the computer 21, the printing data is firstly sent to the SPA server 23. Then, instead of printing the confidential document directly, the SPA server 23 holds the print job down. The confidential document will not be printed out until the user moves to the location of the SPA server 23 and enters a correct user name and password through the PIN pad 25. When the user name and the password are identified as identical to the preset user name and the preset password respectively, the SPA server 23 will allow the confidential document to be printed out from the printer 24. The confidential document 20 can then immediately be taken away by the user as soon as it has been printed out and will not be exposed to other people. Of course, if the user wants to leave for a while, he/she can pause the print job. The print job will be hold down until the user comes back and inputs the correct password again.

The print job can also be delivered to another printer server 26 by the SPA server 23. Before it is printed out by the printer 28, the user must enter the password to the printer server by the PIN pad 27. Only when the entered password and the preset password are identical, the confidential document is printed out from the printer 28. The preset password is provided by the SPA server 23 or the computer 21.

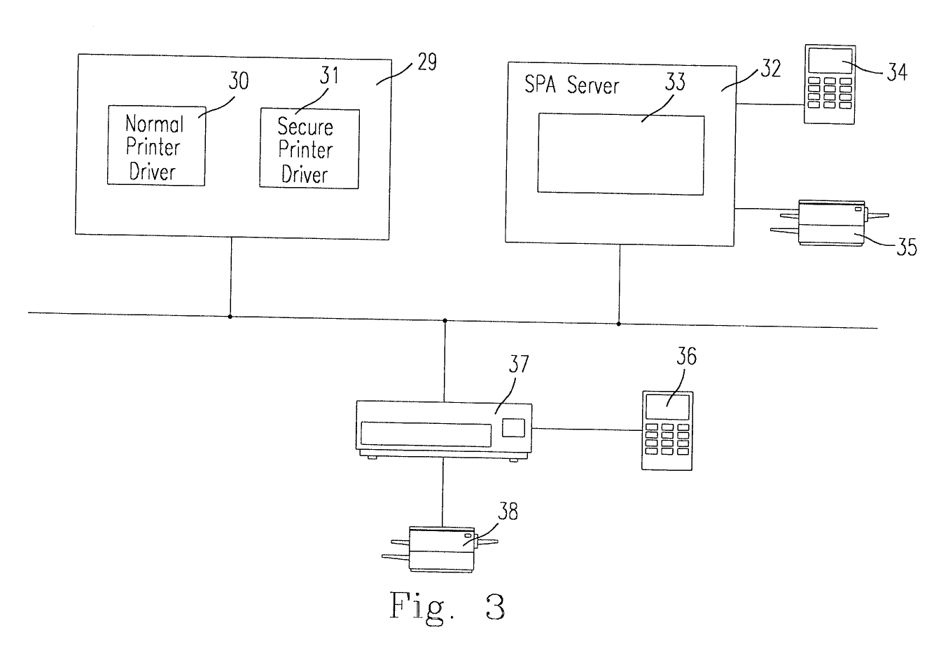

Referring to FIG. 3, the client 29 includes a normal printing operation 30 and a secure printing option 31. The SPA server 32 includes a hard disk 33 for storing therein the print spooler. A PIN pad 34 and a printer 35 are connected to the SPA server 32. Also, the printer server 37 is connected with a PIN pad 36 and a printer 38.

When a confidential document is to be printed, the user selects the confidential printing option 31 in the client 29. The client 29 will then send the print job of this confidential document to the SPA server 32. Since the confidential printing option 31 has been selected, the SPA server 32 will not print out the confidential document until the legal password is entered. The confidential document can be printed out locally form the SPA server 32 or from the other printer server 37. The printer server 37 supports the secure printing architecture.

Of course, if a non-confidential document is to be printed, the user just has to select the normal printing option 30 in the client 29. The SPA server 32 and the printer server 37 will no more check the password and allow the print job to be printed out directly. Of course, the client 29 may be a windows or a Novell system, e.t.c. When the client 29 is a windows system, the normal printing option 30 is executed by a normal printer driver, and the confidential printing option 31 is executed by a secure printer driver.

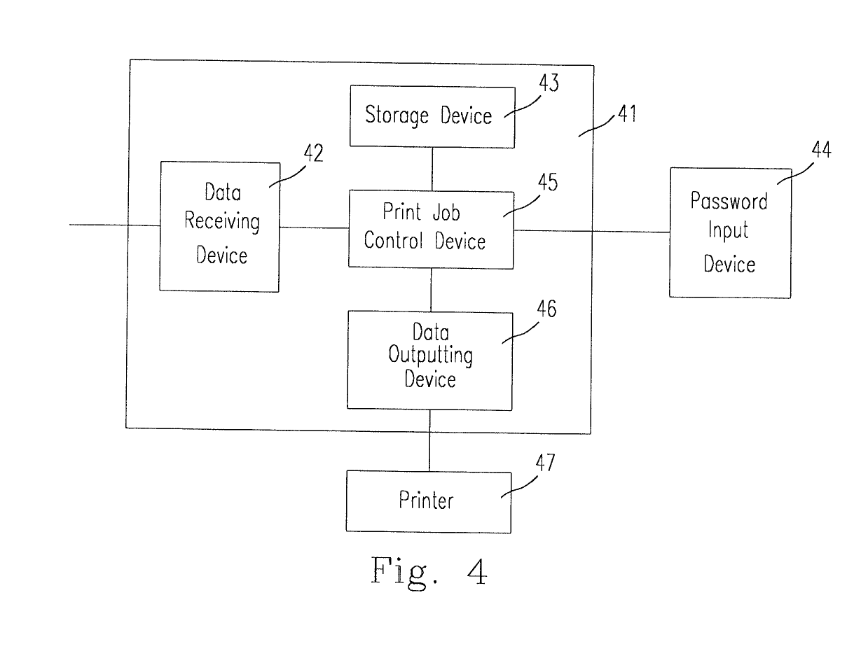

The SPA server or the printer server mentioned above may be represented by the block diagram shown in FIG. 4. The secure printing device 41 includes a data receiving device 42, a storage device 43, a print job control device 45, and a data outputting device 46. The data receiving device 42 is connected to a network as those shown in FIGS. 2 and 3. The data receiving device 42 receives the printing data from the network and then sends the data to the print job control device 45. The print job control device 45 is connected between a password input device 44 and the data receiving device 42. The data outputting device 46 is connected between the print job control device 45 and the printer 47 for outputting the printing data from the print job control device 45 to the printer 47. The storage device 43 is connected to the printer job control device 45. The preset user name and the preset password are stored in the storage device 43.

When the printing data of a confidential document is received from the data receiving device 42, it is hold down by the print job control device 45. The user inputs the user name and the password from the password input device 44. The print job control device 45 will compare between the preset and inputted user names and passwords respectively. Once the inputted and preset user names and passwords are identical, the print job control device 45 will allow the printing data of the confidential document to be outputted from the data outputting device 46 to be printed out by the printer 47.

The storage device 43 may be a hard disk or other storage devices. The user names and their corresponding passwords of the computers on the network may be pre-stored in the storage device. The spooler of the printer server can also stored in the storage device 43. Of course, in another embodiment, the storage device 43 can be omitted. In such a case, the secure printing device 41 is connected to another SPA server (not shown) which will provide both the printing data and the password. The user only has to enter the password form the password input device 44. The print job control device 45 will allow the printing data to be printed when the inputted password is identical to the password sent from the SPA server. The secure printing device 41 may be a specific device or a common purpose computer. When a common purpose personal computer is used, the password and user name can be inputted from the keyboard of the person computer.

To sum up, the present invention provides a securing printing method and device for networking environments. The securing print job can be executed on demand. The confidential document will not be printed out until the correct password is entered to the printer server. Accordingly, the securing printing task is achieved without influencing the printer sharing function of the network.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for printing a confidential document in a network system having a printer connected to a printer server, comprising steps of:
setting a first password for a print job of said confidential document;
sending data of said print job to said printer server and holding down said print job;
inputting a second password into said printer server; and
printing said document by said printer when said first password and said second password are identical.

2. A method according to claim 1 wherein said second password is inputted into said printer server by an input device connected to said printer server.

3. A method according to claim 2 wherein said input device is a personal identification number pad.

4. A method according to claim 2 wherein said printer server is a personal computer.

5. A method according to claim 1, further comprising steps of presetting a first user name and inputting a second user name to said printer server, and said document is printed when said first user name and said first password are identical to said second user name and said second password.

6. A method according to claim 5 wherein said first user name and said first password are preset within said printer server.

7. A method according to claim 6 wherein said printer server includes a storage device for storing said first user name and said first password.

8. A method according to claim 1 wherein said printer server inquires said first password from a storage device.

9. A method according to claim 1 wherein said data of said print job is sent from a client of said network system to said printer server, and said method further comprising a step of selecting a confidential printing option on said client before said data of said print job is sent to said printer server.

10. A method according to claim 9 wherein said first password is inputted into said client when said confidential printing option is selected.

11. A secure printing device adapted to be used with a network having a plurality of computers and a printer, comprising:
a data receiving device for receiving a printing data from one of said plurality of computers;
a password input device for inputting therefrom a password; and
a print job control device electrically connected between said data receiving device and said password input device for holding said printing data down and allowing said printing data to be printed by said printer only when a legal password is inputted from said password input device.

12. A device according to claim 11, further comprising a storage device electrically connected to said print job controlling device for storing therein a pre-stored password, wherein said password inputted by said password input device is identified as said legal password when said password is identical to said pre-stored password.

13. A device according to claim 11 wherein a preset password is inputted from said data receiving device, and said password inputted by said password input device is identified as said legal password when said password is identical to said preset password.

14. A device according to claim 11 wherein a user name is inputted from said password input device together with said password.

15. A device according to claim 14, further comprising a storage device for storing therein a pre-stored user name and a pre-stored password, wherein said password inputted by said password input device is identified as said legal password when said user name and said password are identical to said pre-stored user name and said preset password respectively.

16. A device according to claim 11, further comprising a data outputting device electrically connected between said print job control device and said printer for outputting said printing data to said printer.
